(19) United States
(12) Patent Application Publication
(10) Pub. No.: US 2008/0263554 A1
(43) Pub. Date: Oct. 23, 2008

(54) Method and System for Scheduling User-Level I/O Threads

(75) Inventors: Daniela Rosu, Ossining, NY (US); Marcel Catalin Rosu, Ossining, NY (US)

Correspondence Address: GEORGE A. WILLINGHAN, III;AUGUST LAW GROUP, LLC, P.O. BOX 19080, BALTIMORE, MD, 21284-9080, US

(73) Assignee: INTERNATIONAL BUSINESS MACHINES CORPORATION, Armonk, NY (US)

(21) Appl. No.: 12/166,450

(22) Filed: Jul. 2, 2008

Related U.S. Application Data
(63) Continuation of application No. 10/959,710, filed on Oct. 6, 2004.

(51) Int. Cl. G06F 9/46

(52) U.S. Cl. 718/102

(57) ABSTRACT

The present invention is directed to a user-level thread scheduler that employs a service that propagates at the user level, continuously as it gets updated in the kernel, the kernel-level state necessary to determine if an I/O operation would block or not. In addition, the user-level thread schedulers used systems that propagate at the user level other types of information related to the state and content of active file descriptors. Using this information, the user-level thread package determines when I/O requests can be satisfied without blocking and implements pre-defined scheduling policies.

### CROSS-REFERENCE TO RELATED APPLICATIONS

The present application is a continuation of co-pending U.S. application Ser. No. 10/959,710, filed Oct. 6, 2004. The entire disclosure of that application is incorporated herein by reference.

### FIELD OF THE INVENTION

The present invention relates to user-level thread packages, which are part of the software that manages processing resources on a computer.

### BACKGROUND OF THE INVENTION

User-level thread packages eliminate kernel overhead on thread operations by reducing the number of active kernel threads the operating system must handle and by obviating the need to cross the kernel-user space boundary for concurrency control and context switching operations. Communication intensive Internet applications with thread-based architectures, for example the Apache web server and the IBM WebSphere application server, benefit from a user-level thread package when the number of active application threads is large, which occurs when handling a large number of concurrent connections.

A main concern for the implementation of a user-level thread package is the handling of blocking system calls issued by an application. Examples of these blocking system calls include the read, write, and poll/select input/output (I/O) system calls issued by web server applications. One solution to the handling of blocking system calls is to capture the blocking calls and to replace these blocking calls with non-blocking I/O system calls. When the non-blocking I/O system calls fail, the execution of the threads corresponding to these calls are suspended at the user level until the non-blocking I/O system calls can be satisfied. Another solution takes the opposite approach. Rather than issuing non-blocking I/O system calls and checking whether or not these non-blocking I/O system calls fail, I/O system calls are issued only after a determination is made that the I/O system calls do not block, i.e., that the I/O system calls will be successful. If it is determined that an I/O system call will not be successful, but will fail, then execution of the corresponding thread is suspended until such time as the I/O system call is determined to be successful if executed. Unlike the first solution, no actual attempt to execute the I/O is made.

The user-level thread package contains a user-level thread scheduler. The user-level thread scheduler is responsible for determining when the execution of each thread should be blocked and when the execution should resume. In existing applications of user-level thread packages, the user-level thread scheduler uses software interrupts or other kernel-level mechanisms, for example the select and poll system calls, to track the state of file descriptors of open files and to determine when I/O operations can be executed without blocking. However, using either software interrupts or other kernel level mechanisms to determine when I/O operations can be executed without blocking requires a relatively high overhead. This relatively high overhead results from the requirements of these mechanisms, for example requiring one or more crossings of the kernel-user space boundary. In addition, this overhead increases with the number of file descriptors and the number of threads in the user-level applications.

For scheduling using timesharing, the use of kernel-level mechanisms for tracking the state of the file descriptors for open files results in fewer kernel-user space boundary crossings than result from the use of software interrupts, because the status of the file descriptors does not have to be checked each time a scheduling event occurs. For example, kernel-level tracking mechanisms permit the user-level thread scheduler to check the status of active file descriptors, i.e. open connections, at various times, for example during each scheduling decision, periodically or when no thread is ready to run. For priority-based scheduling, this advantage of kernel-level tracking mechanisms is diminished, because, in order to avoid priority violations, the user-level thread scheduler needs to check active file descriptor status at each scheduling event in order to ensure that higher priority threads run as soon as the related I/O state allows them to. This results in an increase in kernel-user space boundary crossings.

In general, previously employed mechanisms used for scheduling user-level threads resulted in a generally high cost of using the user-level thread package. This high cost is dependent upon the number of file descriptors for open files, i.e. active connections, and the desired accuracy of priority-based scheduling. In addition, this cost increases with an increase in either the number of file descriptors or the level of accuracy.

Another issue in the creation and implementation of a user-level thread package is the selection of the scheduling policies that account for the dynamic characteristics of I/O events. An example of one of these policies is accounting for the amount of data waiting to be read to allow a scheduler to postpone the execution of threads having small payloads until more data arrives or no other thread is ready to run. This policy is created to reduce the user-level overhead of the application. In conventional mechanisms, however, the implementation of this type of scheduling policy has a high associated overhead, because the user-level thread scheduler has to read all of the incoming data in order to assess the available amount of data waiting to be read, to postpone the execution of the thread and to perform additional read operations until the amount of data waiting to be read reaches the threshold chosen for thread execution.

Another example of a scheduling policy is a message-driven scheduling policy, which is a scheduling policy that can be used to implement differentiated service in Internet applications and which is used in the real-time application domain. Message-driven scheduling also incurs high-overhead implementations in UNIX-type operating systems.

The priorities assigned to messages in a message-driven scheduling policy are application specific and are coded either in the transport-layer or in the application headers of the exchanged messages. Various approaches have been used to assign priorities to the messages. In a first approach, two levels of priority are assigned to the messages by using out-of-band and regular traffic. This approach, however, is limited and is too restrictive for applications requiring a larger number of priority levels. In a second approach, multiple levels of priority are assigned to the messages by using priorities defined in an application-specific message header. Since this second approach requires the user-level thread scheduler to read incoming messages before making the scheduling decision, the execution of the highest priority thread can be delayed by the reading of lower priority messages. In a third approach, multiple levels of priority are assigned to the messages by assigning priorities to communication channels that are inherited by the corresponding threads. This solution can result in an increased connection handling overhead when messages originated by the same source have different priority levels, because connections would have to be terminated and reestablished following a change in message priority.

Other mechanisms for user-level thread scheduling have attempted to use kernel-level state information that has been propagated at the user level. These mechanisms, however, do not provide all of the information necessary at the user level to prevent blocking. For example, these mechanisms do not address the state and content of the file descriptors of active files. In one example of the attempted use of propagated kernel-level state information described in “User-level Real-Time Threads: An Approach Towards High Performance Multimedia Threads” by Oikawa, Shuichi and Tokuda, Hideyuki, which is published in the proceedings of 11th IEEE Workshop on Real-Time Operating Systems and Software, 1994, the kernel-level state information propagated at user level provides notifications of changes in thread state information, e.g., blocked, unblocked or suspended, that can be utilized by the user-level thread scheduler to identify when to perform a context switch. This information can also be used to identify the highest-priority active thread. The user-level thread scheduler, however, is not attempting to reduce the user-to-kernel domain crossings.

Another approach employing the propagation of kernel-level state information at the user level is described in “First-Class User-Level Threads”, by Marsh, Brian D., Scott, Michael L., LeBlanc, Thomas J. and Markatos, Evangelos P., which is published in ACM Symposium on Operating System Principles, 1991. In this approach, the kernel-level state information propagated at the user level describes the execution context, i.e. the processor identification, the currently executing virtual processor and the address space, and the identifiers of blocked threads. This approach, however, does not provide any information about active file descriptors that could enable the user-level thread package to prevent blocking I/O operations.

In “Scheduling IPC Mechanisms for Continuous Media”, by Govindan, Ramesh and Anderson, David P., which is published in ACM Symposium on Operating System Principles, 1991, the kernel-level state information that is propagated at the user level includes the readiness of I/O channels for which there are user-level threads blocked for input at the user level. This approach is specifically tailored for user-level threads that read periodically from an input stream and are likely to complete their work and block before the next period begins. Therefore, this approach does not address the need of the user-level thread scheduler for status information on all of the file descriptors of active files of the applications and not just the status information associated with blocking threads and selected content segments extracted from the message stream.

Therefore, a need still exists for a user-level thread scheduling method that reduces the overhead when handling an I/O bound workload with a large number of active threads. The user-level thread scheduling method would also permit effective implementation of scheduling policies that account for the dynamic characteristics of the I/O events, for example available payload and application-specific priorities.

### SUMMARY OF THE INVENTION

The present invention is directed to a user-level thread scheduler that employs a service that propagates at the user level, continuously as it gets updated in the kernel, the kernel-level state information necessary to determine if an I/O operation would block or not. The kernel-level state information is preferably application specific, i.e. contains only that information that is relevant to the applications that are running at the user level, and includes kernel-level information related to the state and content of active file descriptors. Using this information, the user-level thread package can efficiently determine when I/O requests can be satisfied without blocking and can implement useful scheduling policies. For instance, available-payload based policies are implemented by exporting the number of bytes waiting to be read from a socket. Message-driven priorities are implemented by exporting the out-of-band characteristics of the message or the value in a preset segment of the payload.

The present invention reduces the number of system calls that the user-level thread scheduler executes in order to determine when I/O operations are blocking and reduces the number of system calls and the application-level overhead incurred by the implementation of priority policies that account for the dynamic characteristics of I/O events.

### BRIEF DESCRIPTION OF THE DRAWINGS

FIG. 1 a schematic representation of a user-level thread package in accordance with the present invention;

FIG. 2 is a flow chart illustrating an embodiment of a method for using global state information propagated at the user level to schedule execution of threads in accordance with the present invention; and

FIG. 3 is a schematic representation of an embodiment for the propagation of global state information at the user level for use in the present invention.

### DETAILED DESCRIPTION

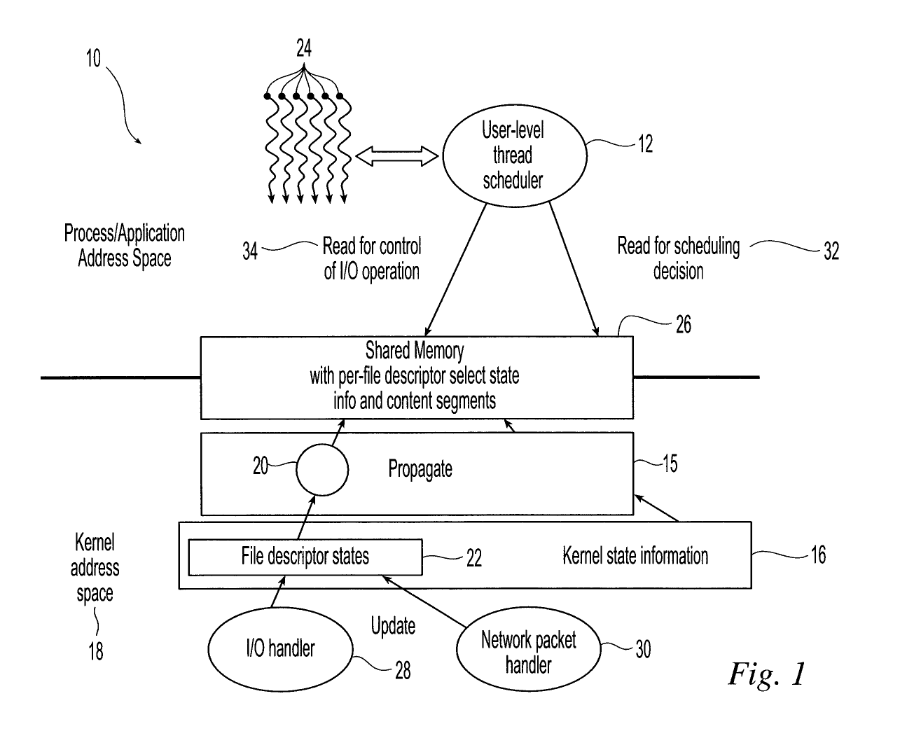

Referring initially to FIG. 1, an embodiment of a user-level thread package 10 in accordance with the present invention is illustrated. The user-level thread package 10 includes a user-level thread scheduler 12 that is capable of scheduling the sequence of execution of a plurality of threads 24 for a user-level process or application based upon kernel-level state information including information to determine if an I/O operation would block or not and file descriptor information for active files. In order for the user-level thread scheduler 12 to be able to access the information necessary to determine the scheduling sequence of the plurality of threads 24, the user-level thread package 10 has access to or includes at least one user-level accessible memory location 26 in communication with the user-level thread scheduler 12. The user-level memory location is accessible by the user-level thread scheduler without using system calls but with standard memory reads and writes, user-level library calls and combinations thereof. Preferably, the user-level accessible memory location 26 is a shared memory location that is located in both the user space, also referred to as the application space or user level, and the kernel space. In the shared memory location, the same bits of physical memory are mapped in the kernel address space and in the address space of at least one user-level application. The user-level memory location 26 can be disposed in any computer readable storage medium accessible to the user-level thread package 10 and the kernel and is preferably a computer readable storage medium disposed within or placed in communication with the computer hardware system executing the user-level application.

In order to propagate at the user-level memory location 26 the information necessary to schedule the plurality of threads, the user-level thread package includes at least one kernel module 15. In one embodiment, the kernel module 15 acts as a kernel-level state information propagation system. This kernel-level state information propagation system 15 propagates kernel state information 16 from the kernel-level or kernel address space 18 to the user-level memory location 26. The kernel-level state information system includes a file descriptor propagation system 20. The file descriptor propagation system 20 propagates file descriptor information 22 for active files from the kernel address space 18 to the user-level memory location 26. Preferably, this information is propagated continuously, regularly or periodically as it is updated in the kernel, for example by I/O handlers 28 and network packet handlers 30. The user-level thread scheduler 12 is in communication with the user-level memory location 26 both for reading the propagated kernel-level information for purposes of scheduling the plurality of threads 32 and for purposes of controlling I/O operations of the plurality of threads 34. Examples of suitable kernel-level state information propagation systems including file descriptor propagation systems and methods for their use are described below.

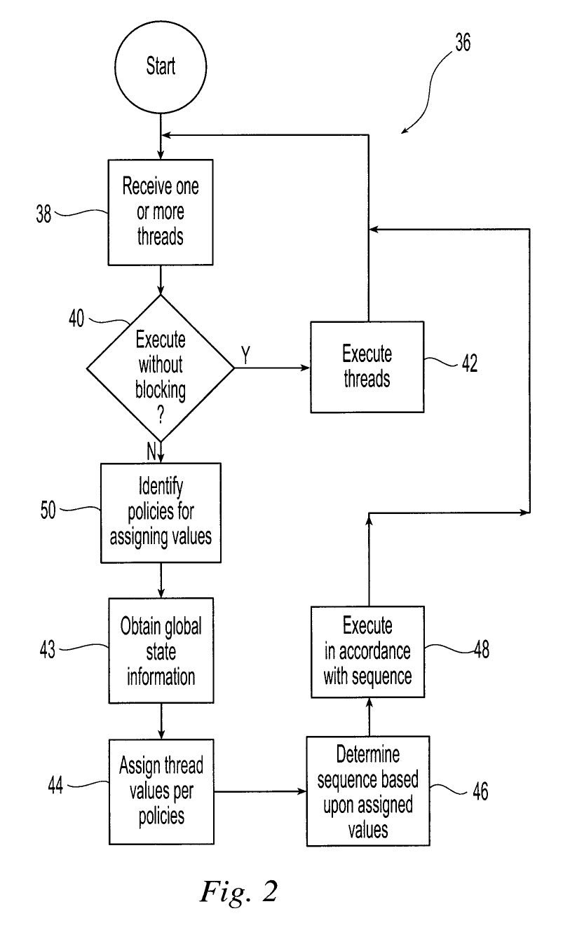

Referring to FIG. 2, an embodiment of a method for scheduling threads using the user-level thread scheduler 30 in accordance with the present invention is illustrated. The user-level application or process receives or identifies one or more threads to be executed 38. These threads are associated with one or more I/O operation, and the execution of these threads has the potential to result in blocking. In order to avoid any potential blocking, the global state information that has been propagated or published at the user level by the kernel is used by the user-level thread scheduler to determine a sequence for executing the threads. In general, global state information refers to information that is known to the kernel and includes all of the information that is available to the kernel that can be used to optimize the running of a thread or used by a scheduler, such as the user-level thread scheduler, to determine the value or priority of a thread. Examples of the global state information include, but are not limited to, information about the number of available bytes in a socket that are available for read, the number of free bytes in a socket that are available for write, information on whether or not a particular destination is starving and information about the priority of an I/O operation at the opposite end of that operation. The propagated kernel-level information also includes state and content information regarding file descriptors associated with active files. In one embodiment, the propagated global state information contains a sufficient amount of kernel-level information to permit the user-level thread scheduler to determine the sequence of executing the threads to avoid blocking. Using this information, the user-level thread package implements scheduling policies and determines when I/O requests can be satisfied without blocking. By propagating a sufficient amount of information to the user-level to permit the user-level thread scheduler to schedule and to execute threads, the present invention enables the user-level thread scheduler to avoid initiating many, if any, system calls to obtain information necessary to schedule and execute the operation threads.

In one embodiment, the user-level thread scheduler initially uses the propagated global state information to determine if each of the identified threads can be executed without blocking 40. If the threads can be executed without blocking, then the threads are executed 42, preferably in an order in accordance with the I/O operation with which they are associated.

If one or more of the identified threads cannot be executed without blocking, then a sequence for the execution of the threads is determined so as to avoid blocking. This determination is made using the propagated global state information. In one embodiment, the user-level thread scheduler obtains the propagated state information 43 and uses this information to assign a value to each thread 44. These assigned values can be static or can change dynamically as the propagated global state information changes or is updated. Once the values are assigned to the threads, a sequence or schedule for the execution of the threads is determined 46 based upon these values. In one embodiment, the threads are assigned values based upon the amount of data to be read during execution of the thread, and the thread having the largest amount of data to read is scheduled to be executed first.

In one embodiment, one or more polices are identified, 50, and these policies are utilized when assigning values to each thread 44 based upon the current content of the global state information. These policies can be pre-defined policies and can be associated with the user-level application. Suitable policies include available payload-based policies, message-driven policies, application-specific policies and combinations thereof. An example of an available payload-based policy exports the number of bytes waiting to be read from a socket. An example of a message-driven policy exports the out-of-band characteristics of a message. As used herein, out-of-band message characteristics refer to data that describe qualities of a message, for example the priority of a message. For example, a message can be associated with either urgent or non-urgent bytes in TCP/IP. Another example of a message-driven policy exports the value in a preset segment of the payload.

The global state information and active file descriptor information used to determine the value of each thread is propagated at a user-level memory location. In one embodiment, propagation of the global state information is done continuously or at regular intervals to capture and to propagate changes that occur over time in the kernel-level information. The global state information is preferably propagated to a user-level memory location within the address space of the process or application initiating the I/O operation using the threads. The user-level thread scheduler accesses the global state information from this user-level memory location. Since the memory location is located at the user-level, the need for system calls to access this information is eliminated, and the user-level thread schedule accesses this information using conventional memory reads and writes, user-level library calls and combinations thereof.

An example of a system and method for use in the kernel-level state information propagation system and the file descriptor propagation system is described in US PTO Published application number 20040103221, “Application-Level Access to Kernel Input/Output State”, which is incorporated herein by reference in its entirety. In general, the system and method utilize a memory region, e.g. the user-level memory location 26, shared between the kernel and the user-level application. The kernel propagates kernel-level information, for example, elements of the transport and socket-layer state of the application, such as the existence of data in receive buffers or of free space in send buffers. The mechanism used to propagate the information is secure, because only information pertaining to connections associated with the application is provided to the shared memory location, and each application has a separate memory region which contains only information pertaining to connections associated with that application.

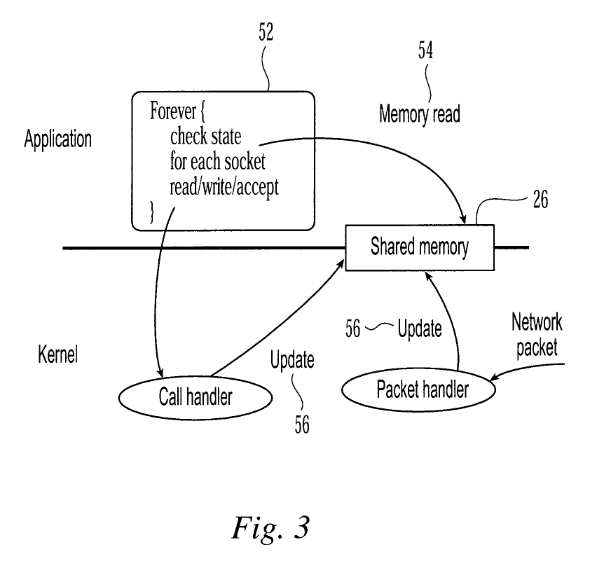

Referring to FIG. 3, kernel-level information, for example socket-layer or transport-layer information, is propagated at the user-level in the memory location 26 that is shared between the kernel and the application. The application 52 retrieves the propagated information using memory read operations 54, without any context switches or data copies. The propagation mechanism does not require any system calls for connection registration or deregistration. All connections created after the application registers with the mechanism are automatically tracked at user-level until closed.

The mechanism allows for multiple implementations, depending on the set of state elements propagated at user level. For example, in order to implement the select/poll-type connection state tracking application programming interfaces (API's), the set includes elements that describe the states of send and receive socket buffers. Similarly, the representation of state elements in the shared memory region depends on the implementation. For example, for the select/poll-type tracking, the representation can be a bit vector, with bits set if read/write can be performed on the corresponding sockets without blocking, or it can be an integer vector, with values indicating the number of bytes available for read/write.

The same set of state elements is associated with all of the connections associated with the application. The data structures in the shared region are large enough to accommodate the maximum number of files a process can open. However, the shared memory region is typically small. For example, an application with 65K concurrent connections and using 16 bytes per connection requires a 1 MByte region, which is a small fraction of the physical memory of an Internet server. In addition to direct memory reads and writes, applications can access the shared memory region through user-level library calls. For instance, when the shared state includes information on socket-buffer availability, the application can use user-level wrappers for select/poll. These wrappers return a non-zero reply using the information in the shared region. If the parameters include file descriptors not tracked at user level or a nonzero timeout, the wrappers fall back on the corresponding system calls.

In one embodiment, the kernel updates the shared memory location or region 26 during transport and socket layer processing, and at the end of read and write system calls. Preferably, the memory location 26 is not pageable, and updates are implemented using atomic memory operations. The cost associated with updating variables in the shared memory region is a negligible fraction of the CPU overhead of sending or receiving a packet or of executing a read/write system call. The kernel exploits the modular implementation of the socket and transport layers.

In Linux, for example, the socket layer interface is structured as a collection of function pointers, aggregated as fields of a “struct proto ops” structure. For IPv4 stream sockets, the corresponding variable is “inet stream ops”. This is accessible through pointers from each TCP socket and includes pointers to the functions that support the read, write, select/poll, accept, connect, and close system calls. Similarly, the transport layer interface is described by a struct proto variable called “tcp prot”, which includes pointers for the functions invoked upon TCP socket creation and destruction. In addition, each TCP socket is associated with several callbacks that are invoked when events occur on the associated connection, such as packet arrival or state change.

In order to track a TCP connection at the user level, the kernel replaces some of these functions and callbacks. The replacements capture socket state changes, filter the state changes and propagate them in the shared region. Connection tracking starts upon return from the connect or accept system calls. To avoid changing the kernel source tree, in this implementation, the tracking of accept-ed connections starts upon return from the first select/poll system call.

In one embodiment, a connection-state tracking mechanism is used to implement uselect, a user-level tracking mechanism having the same API as select. In this embodiment, the memory location 26 includes four bitmaps, the Active, Read, Write, and Except bitmaps. The Active bitmap, A-bits, records whether a socket/file descriptor is tracked, i.e., monitored, at user level. The Read and Write bitmaps, R- and W-bits, signal the existence of data in receive buffers and of free space in send buffers, respectively. The Except bitmap, E-bits, signals exceptional conditions. The implementation includes a user or application-level library and a kernel component. The library includes uselect, a wrapper for the select system call, uselect_init, a function that initializes the application, kernel components and the shared memory region, and get_socket_state, a function that returns the read/write state of a socket by accessing the corresponding R- and W-bits in the shared region.

The uselect wrapper, containing, for example, about 650 lines of C code, is composed of several steps as illustrated below.

int uselect(maxfd, readfds, writefds, exceptfds, timeout) {

static int numPass = 0;
int nbits;
nbits = BITS ON(readfds& R-bits& A-bits)

+ BITS ON(writefds& W-bits& A-bits)
+ BITS ON(exceptfds& E-bits& A-bits);

if(nbits > 0 && numPass < MaxPass) {

adjust readfds,writefds,exceptfds numPass++;

}else {

adjust & save maxfd,readfds,writefds,exceptfds
nbits = select(maxfd,readfds,...)
numPass = 0;
if( proxy socket set in readfds) {

check R/W/E-bits
adjust nbits,readfds,writefds,exceptfds

}

}
return nbits;

}

First, the procedure checks the relevant information available at the user-level by performing bitwise AND between the bitmaps provided as parameters and the shared-memory bitmaps. For instance, the readfds bitmap is checked against the A- and R-bitmaps. If the result of any of the three bitwise AND's is nonzero, uselect modifies the input bitmaps appropriately and returns the total number of bits set in the three arrays; otherwise, uselect calls select. In addition, select is called after a predefined number of successful user-level executions in order to avoid starving I/O operations on descriptors that do not correspond to connections tracked at user level (e.g., files, UDP sockets).

When calling select, the wrapper uses a dedicated TCP socket, called a proxy socket, to communicate with the kernel component. The proxy socket is created at initialization time and it is unconnected. Before the system call, the bits corresponding to the active sockets are masked off in the input bitmaps, and the bit for the proxy socket is set in the read bitmap. The maxfd is adjusted accordingly, typically resulting in a much lower value, and the timeout is left unchanged. When an I/O event occurs on any of the ‘active’ sockets, the kernel component wakes-up the application that is waiting on the proxy socket. Preferably, the application does not wait on active sockets, as these bits are masked off before calling select. Upon return from the system call, if the bit for the proxy socket is set, a search is performed on the R-, W-, and E-bit arrays. Using a saved copy of the input bitmaps, bits are set for the sockets tracked at user level and whose new states match the application's interests.

The uselect implementation includes optimizations, which are not illustrated above for purposes of simplicity. For instance, counting the “on” bits, adjusting the input arrays, and saving the bits reset during the adjustment are performed before calling select are all executed in the same pass.

Despite the identical API, uselect contains slightly different semantics than select. Namely, select collects information on all file descriptors indicated in the input bitmaps. In contrast, uselect might ignore the descriptors not tracked at user level for several invocations. This difference is rarely an issue for Web applications, which call uselect in an infinite loop.

The uselect kernel component is structured as a device driver module, for example containing about 1500 lines of C code. Upon initialization, this module modifies the system's tcp_prot data structure, replacing the handler used by the socket system call with a wrapper. For processes registered with the module, the wrapper assigns to the new socket a copy of inet_stream_ops with new handlers for recvmsg, sendmsg, accept, connect, poll, and release.

The new handlers are wrappers for the original routines. Upon return, these wrappers update the bitmaps in the shared region according to the new state of the socket. The file descriptor index of the socket is used to determine the update location in the shared region.

The recvmsg, sendmsg, and accept handlers update the R-, W-, or E-bits under the same conditions as the original poll function. In addition, accept assigns the modified copy of inet_stream_ops to the newly created socket.

Replacing the poll handler, which supports select/poll system calls, is used in a Linux implementation, because a socket created by accept is assigned a file descriptor index after the return from the accept handler. For a socket of a registered process, the new poll handler determines its file descriptor index by searching the file descriptor array of the current process. The index is saved in an unused field of the socket data structure, from where it is retrieved by event handlers. Further, this function replaces the socket's data_ready, write_space, error report and state_change event handlers, and sets the corresponding A-bit, which initiates the user-level tracking and prevents future poll invocations. On return, the handler calls the original tcp_poll.

The connect handler performs the same actions as the poll handler. The release handler reverses the actions of the connect/poll handlers.

The event handlers update the R-, W-, and E-bits like the original poll, set the R-bit of the proxy socket, and unblock any waiting threads.

Systems and methods in accordance with the present invention reduce the number of system calls that the user-level thread scheduler executes in order to determine when I/O operations are blocking and reduce the number of system calls and the application-level overhead incurred by the implementation of priority policies that account for the dynamic characteristics of I/O events.

Systems and methods in accordance with the present invention result in significant, for example about 50% to about 80%, reductions in the overhead incurred by a user-level thread scheduler when handling the threads blocked on I/O events. In addition, the scheduler implements scheduling policies that reduce the user-level overheads, e.g., Apache processing of incoming blocks smaller than 8 Kbytes, and enables the provisioning of differentiated service without the need to use an individual connection for each priority level between the sender and receiver.

In an embodiment utilizing Apache processing, Apache is modified to run on top of a user-level threads package library that uses uselect instead of the regular select/poll system calls. In one embodiment, either the Next Generation POSIX Threading (NGPT) package or the GNU Portable Threads (GPT) package is modified to use uselect. For example, at initialization time, the package's user-level scheduler thread invokes the uselect_init call to registers with the uselect kernel-level component. The call is issued before the package's internal event-notification socket is created; therefore, the socket is tracked at the user level. Because this call occurs before the Apache accept socket is created, the accept socket is also tracked at the user level.

The library procedures that mask the read and write system calls are modified to use the get_socket_state to check the I/O state before issuing a system call. In one embodiment where blocking is expected, the current thread is registered for waiting on the particular I/O event and suspends itself. When the user-level thread scheduler checks the I/O of the blocked threads, for example at every scheduling decision, the thread scheduler calls the uselect library procedure with a set of bitmaps that indicate the file descriptors on which threads wait for read, write and exception events, respectively.

In one embodiment, the procedure is optimized by using a set of package-level file descriptor bitmaps that are set by the Apache worker threads, for example just before they suspend themselves waiting on I/O events. This embodiment eliminates the need to traverse, in the scheduling procedure, the possibly long list of blocking events of the user-level thread package. The bitmaps that are used as parameters for the uselect call are copies of the package-level file descriptor bitmaps. Alternatively, the procedure is optimized by having the user-level thread scheduler directly access the bitmaps in the shared memory region between the kernel space and the user space, eliminating the need to copy package-level file descriptor bitmaps and other bitmap-relate processing.

The present invention is also directed to a computer readable medium containing a computer executable code that when read by a computer causes the computer to perform a method for using the global state information propagated at the user-level in the user-level thread scheduler to schedule the execution of threads in accordance with the present invention and to the computer executable code itself. The computer executable code can be stored on any suitable storage medium or database, including databases in communication with and accessible at the kernel level and the user-level, and can be executed on any suitable hardware platform as are known and available in the art.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s). Therefore, it will be understood that the appended claims are intended to cover all such modifications and embodiments, which would come within the spirit and scope of the present invention.

What is claimed is:

1. A method for scheduling threads using a user-level thread scheduler, the method comprising:
using global state information published at a user level by a kernel module to determine a sequence for executing the threads;
wherein the published global state information comprises a sufficient amount of kernel-level information to permit the user-level thread scheduler to determine the sequence of executing the threads.

2. The method of claim 1, wherein the global state information comprises file descriptor information for active files.

3. The method of claim 1, wherein the step of using the global state information comprises determining if each thread can be executed without blocking.

4. The method of claim 1, wherein the step of using the global state information comprises:
assigning a value with each thread; and
determining the sequence of execution based upon the assigned thread values.

5. The method of claim 4, wherein the step of assigning a value comprises using one or more policies to determine the assigned value for each thread.

6. The method of claim 5, wherein the policies comprise available payload based policies, message-driven policies, application-specific policies or combinations thereof.

7. The method of claim 1, further comprising continuously publishing updated global state information at the user-level.

8. The method of claim 1, further comprising accessing the published global state information using conventional memory reads and writes, user-level library calls or combinations thereof.

9. A computer readable medium containing a computer executable code that when read by a computer causes the computer to perform a method for scheduling threads using a user-level thread scheduler, the method comprising:
using global state information published at a user level by a kernel module to determine a sequence for executing the threads;
wherein the published global state information comprises a sufficient amount of kernel-level information to permit the user-level thread scheduler to determine the sequence of executing the threads.

10. The computer readable medium of claim 9, wherein the global state information comprises file descriptor information for active files.

11. The computer readable medium of claim 9, wherein the step of using the global state information comprises determining if each thread can be executed without blocking.

12. The computer readable medium of claim 9, wherein the step of using the global state information comprises:
assigning a value with each thread; and
determining the sequence of execution based upon the assigned thread values.

13. The computer readable medium of claim 12, wherein the step of assigning a value comprises using one or more policies to determine the assigned value for each thread.

14. The computer readable medium of claim 13, wherein the policies comprise available payload based policies, message-driven policies, application-specific policies or combinations thereof.

15. The computer readable medium of claim 9, further comprising continuously publishing updated global state information at the user-level.

16. The computer readable medium of claim 9, further comprising accessing the published global state information using conventional memory reads and writes, user-level library calls or combinations thereof.

17. A user-level thread package comprising:
a user-level thread scheduler capable of scheduling execution of a plurality of threads based upon kernel-level state information published at the user-level;
wherein the user-level thread package utilizes a kernel-level state information propagation system to publish the kernel-level state information at the user-level.

18. The user-level thread package of claim 17, wherein the kernel-level state information propagation system comprises a file descriptor propagation system to publish file descriptor information for active files at the user level.
